(19) United States
(12) Patent Application Publication
(10) Pub. No.: US 2004/0163778 A1
(43) Pub. Date: Aug. 26, 2004

(54) Modular multi-configurable display system

(76) Inventors: Mark Fritsche, Eagan, MN (US); Dan Berg, Minneapolis, MN (US); Jason Johnson, Minneapolis, MN (US); Gordon Savoie, Minneapolis (MN)

Correspondence Address: PATTERSON, THUENTE, SKAAR & CHRISTENSEN, P.A., 4800 IDS CENTER, 80 SOUTH 8TH STREET, MINNEAPOLIS, MN, 55402-2100, US

(21) Appl. No.: 10/662,132

(22) Filed: Sep. 12, 2003

Related U.S. Application Data
(63) Continuation-in-part of application No. 09/953,113, filed on Sep. 13, 2001, now abandoned.

(51) Int. Cl. E06B 3/30; A47G 5/00; E06B 9/24

(52) U.S. Cl. 160/371

(57) ABSTRACT

A modular multi-configurable display system includes multiple interchangeable components. The system includes a plurality of vertical columns, a plurality of horizontal trusses members, which may be arcuate or linear, and optionally a plurality of extension modules. The columns are capable of removably receiving the horizontal arcuate and linear members or extension modules at each end of the columns. Each column may be formed of one or typically two elongated box frames that are removably stackable and connectable with respect to each other or with extension modules. Each box frame has elongate frame members secured and braced with webbing only at the ends. The elongate frame members are free from webbing or bracing between the end webbings. Appurtenant components, such as shelves or tables, may be attached at any desired location along the bracing-free length of the columns.

### RELATED APPLICATIONS

The present application is a continuation-in-part application of co-pending U.S. patent application Ser. No. 09/953,113 filed Sep. 13, 2001, entitled, “MODULAR MULTI-CONFIGURABLE DISPLAY SYSTEM”, hereby fully incorporated by reference herein in its entirety.

### FIELD OF THE INVENTION

The present invention relates to displays, and in particular, to a modular display system for the multi-configurable assembly of a display stand at a trade show or other exhibition.

### BACKGROUND OF THE INVENTION

Trade shows have been common for some time as a means for companies to significantly expand their client base. Generally, a trade show exhibitor is allocated a specific limited space within a large hall in which to set up a booth or display. It has been common practice for these exhibitors to purchase specially designed displays to showcase their products or services.

These conventional displays usually include a “back wall.” This back wall is set as the focal point for the exhibition. However, while these back walls have generally been readily available and portable, they are often very limited in their use and can be quite expensive. For the most part, the currently available back walls come in limited configurations, with the display manufacturer designing a back wall specifically for the exhibitor. Consequently, conventional back walls are truly customized and are only capable of a limited number of configurations. Rectangular paneled back walls are often the only real configuration option and the exhibitor is only able to modify the look of the wall through the addition of furniture and shelves at predetermined locations.

The lack of configuration flexibility is problematic. First, trade show facilities can vary greatly. The overall size and shape of the exhibit space is an important consideration. A small space may require a reduction in the size of the back wall, while a larger space may present opportunities for the exhibitor to expand the wall and the draw or appeal of the exhibited products or services. In addition, a uniquely shaped booth space may present a problem for those exhibitors utilizing conventional back wall displays since the wall cannot be configured to conform with the space.

Second, exhibitors may wish to periodically change the configuration of the back wall for non-functional reasons. An exhibitor may simply wish to have options available to vary the look of the back wall in order to highlight specific products, influence a particular trade show audience, or for many other creative and aesthetic reasons. However, conventional back wall display systems are generally limited in this respect.

Limited component shapes, such as those used in rectangular panel systems, restrict the ability of an exhibitor to creatively configure the wall. Consequently, there is a need for a display booth back wall system that includes various components of convenient interchangeable shapes and sizes that permit an exhibitor to assemble the wall in a myriad of modular configurations. In addition, there is a need for a lightweight system, that is easily disassemblable and portable to accommodate the demands of trade show exhibitors.

### SUMMARY OF THE INVENTION

The present invention substantially meets the needs of the industry for a lightweight, structurally rigid, flexibly multi-configurable, modular display structure. The modular multi-configurable display system of the present invention includes multiple interchangeable components. Generally, the system includes a plurality of vertical columns, a plurality of horizontal trusses members, which may be arcuate or linear, and optionally a plurality of extension modules. The columns are capable of fixedly removably receiving the horizontal arcuate and linear members at each end of the columns. Each column may be formed of one or typically two elongated box frames that are removably stackable and connectable with respect to each other or with extension modules. Each box frame has elongate frame members secured and braced with webbing only at the ends. The elongate frame members are free from webbing or bracing between the end webbings. Appurtenant components, such as shelves or tables, may be attached at any desired location along the bracing-free length of the columns.

Similarly, in a preferred embodiment, the trusses have only end webbing with no intermediate webbing or bracing, thereby providing substantially the entire length of the truss for attachment positions for appurtenances. A myriad of modular configuration combinations are available to an exhibitor.

The invention may also generally include an elongated columnar structure for use in constructing displays having at least one elongate substantially open paralellpiped structure having a pair of opposing ends. The parallelpiped structure includes a plurality of spaced apart elongate members operably coupled by a pair of spaced apart opposing end webbing members. Each elongate member defines an outside corner of the parallelpiped structure. The column further includes at least one extension module selectively couplable with one of the ends of the paralellpiped structure. The extension module includes a hollow, sheet metal enclosure having at least a top, a bottom, and four sides, the four sides intersecting at four outside corners. Each of the four outside corners of the extension module align with a separate one of the outside corners of the paralellpiped structure when the extension module is coupled with the parallelpiped structure.

A parallelpiped structure according to the invention generally includes a plurality of frame segments with webbing attached to each end of the plurality of frame segments and no webbing intermediate the tubing ends. The plurality of frame segments are attached to the end piece such that a column-like structure is formed. The inner space defined within the frame segments is substantially free of webbing. Instead, structural strength and stability is achieved by the end webbing. The end of one elongated box frame structure is capable of removably connecting with the end piece of other similar elongated box frame structures to achieve varying framing heights and other dynamic configurations.

The absence of webbing and other bracing intermediate the ends is a significant feature and advantage that in itself generates other features and advantages.

A significant feature and advantage of utilizing an elongated box frame assembly free of webbing is that it is aesthetically appealing. Visual appeal is essential in trade show displays and other exhibition environments.

Another significant feature and advantage of eliminating webbing in the present invention is that manufacturing and material costs are significantly reduced since fewer components are required. Reduced components provide a benefit to the end user as well by simplifying assembly and disassembly.

A further feature and advantage of the column structure according to the present invention centers around frame attachments, such as shelving. The absence of space limiting webbing means that there are significantly more attachment and grasping points along the entire length of each frame segment. As a result, a valuable proliferation in configuration options is made available to the end user.

Further features and advantages of the present invention relate to the extension module. The extension module of the present invention may be connected with other extension modules, paralellpiped box frames, trusses, or any other modular display component to form a multiplicity of unique, selectively configurable, display configurations. Center and corner apertures significantly lighten the extension module without compromising structural integrity of the column. All three adjacent sides of the extension module meet and engage at each corner for optimal structural strength and rigidity. Thus, the extension module combined with the open, bracing free, parallelpiped structure of the box frame of the present invention, which also is advantageously light and structurally rigid, offers a flexibly configurable, lightweight, structurally rigid, and aesthetically pleasing column assembly for a display structure.

Another significant advantage and feature of the modular multi-configurable display system of the present invention is that configuration options are increased to accommodate an exhibitor's specific needs or creative desires.

Another significant advantage and feature of the present invention is its modular interchangeability and connectability. Each modular component (i.e., the arcuate and linear members) is in connectable communication with other components of identical or different design through an intermediary connection with a frame assembly. Common connectability with a frame assembly permits flexibility in defining the overall shape and size of the display. In addition, a specific component is not directed or limited to a particular connection position, or to an individually designated frame assembly. This significantly increases the ease of assembly and decreases the time associated with assembly and disassembly.

The following U.S. Patent Applications, commonly owned by the owner of the present invention, are hereby fully incorporated herein by reference: U.S. patent application Ser. No. 09/953,098, entitled “DISPLAY WITH APPURTENANCE ATTACHMENT”; U.S. patent application Ser. No. 09/953,099, entitled “SCREEN MOUNTING APPARATUS”; U.S. patent application Ser. No. 09/953,111, entitled, “BOX FRAME ASSEMBLY”; U.S. patent application Ser. No.______, filed Sep. 9, 2003, entitled “COLUMN ASSEMBLY FOR DISPLAY FRAME”; and U.S. patent application Ser. No. 10/601,843, entitled “FRAMEWORK CONNECTION SYSTEM”.

### BRIEF DESCRIPTION OF THE DRAWINGS

FIG. 1 is a perspective view of a display in accordance with the invention herein;

FIG. 1a is a plan view of one configuration of the modular multi-configurable display wall system of the present invention;

FIG. 1b is a plan view of another configuration of the modular multi-configurable display wall system of the present invention;

FIG. 1c is a plan view of yet another configuration of the modular multi-configurable display wall system of the present invention.

FIG. 2 is a front perspective view of a framework for a display;

FIG. 3 is a exploded view of a column in accordance with the invention herein;

FIG. 4 is an exploded view of the connection between a elongate box frame and a truss;

FIG. 5 is a plan view of a stamping for forming an end webbing;

FIG. 5b is a perspective view of a formed end webbing;

FIG. 6 is a perspective view of an elongate box frame, a truss and a graphic screen;

FIG. 7 is a perspective view of an elongate box frame and appurtenance attachment means;

FIG. 8 is a perspective view of a table adjustably mounted on an elongate box frame;

FIG. 9 is a perspective view of an extension module according to the present invention;

FIG. 10 is an enlarged view of a comer of the extension module of FIG. 9;

FIG. 11 is a side elevation view of one body component of the extension module depicted in FIG. 9;

FIG. 11a is a plan view of a plate for forming a body component of the extension module;

FIG. 11b is an exploded view of an embodiment of the extension module;

FIG. 12 is a front elevation view of the body component depicted in FIG. 11;

FIG. 13 is a bottom plan view of the body component depicted in FIG. 11;

FIG. 14 is a perspective view of an extension module according to the present invention assembled with a pair of box frame members to form a column structure;

FIG. 14a is a perspective view of an exemplary multi-level display structure in accordance with the invention;

FIG. 14b is an enlarged view of a portion of the view of FIG. 14a depicting connections of vertical columns and horizontal trusses with extension modules;

FIG. 15 is a perspective view of a screen in accordance with the invention;

FIG. 16 is a side elevational view of a screen mounting apparatus in accordance with the invention;

FIG. 17 is an alternative embodiment of a screen mounting apparatus in accordance with the invention; and

FIG. 18 is another alternative embodiment of a screen mounting apparatus in accordance with the invention.

### DETAILED DESCRIPTION OF PREFERRED EMBODIMENTS

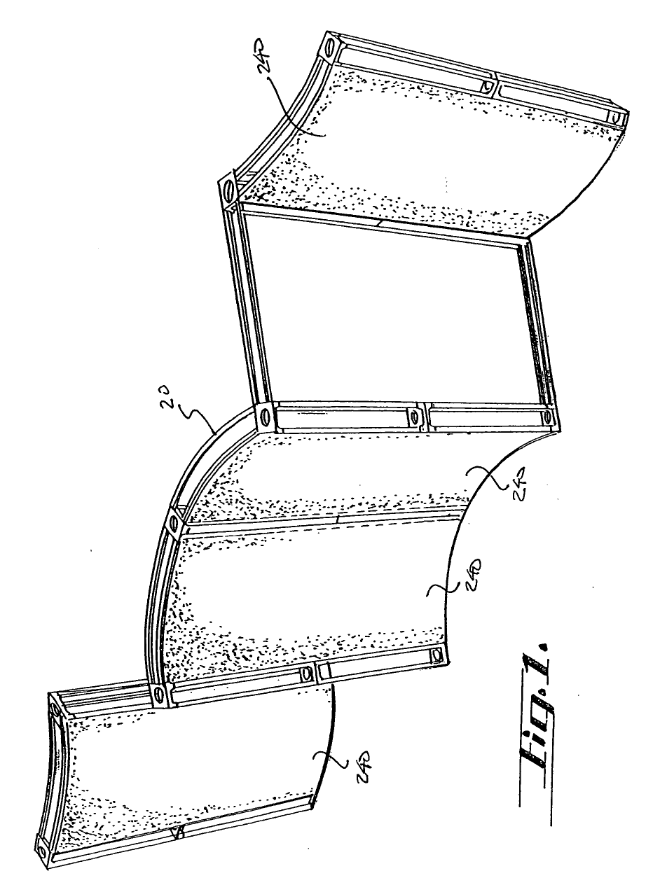

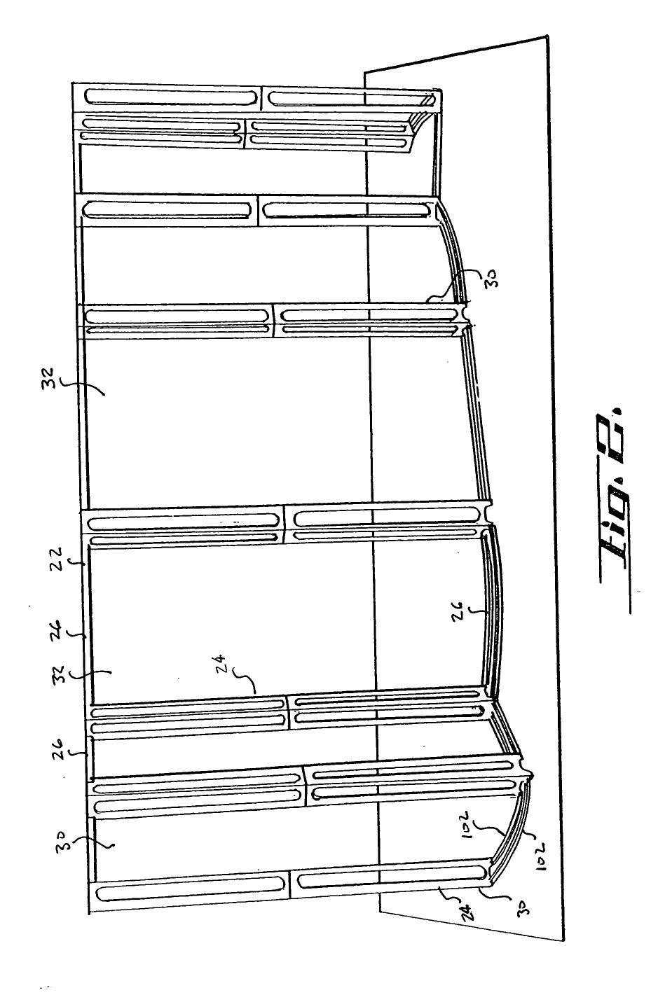

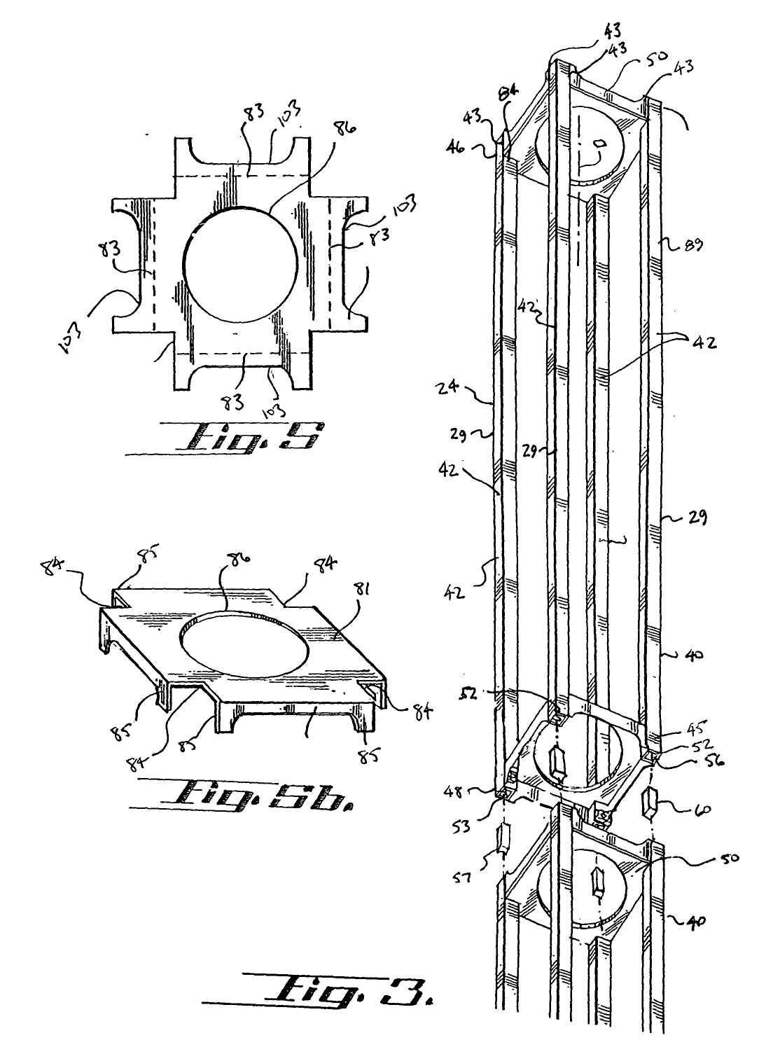

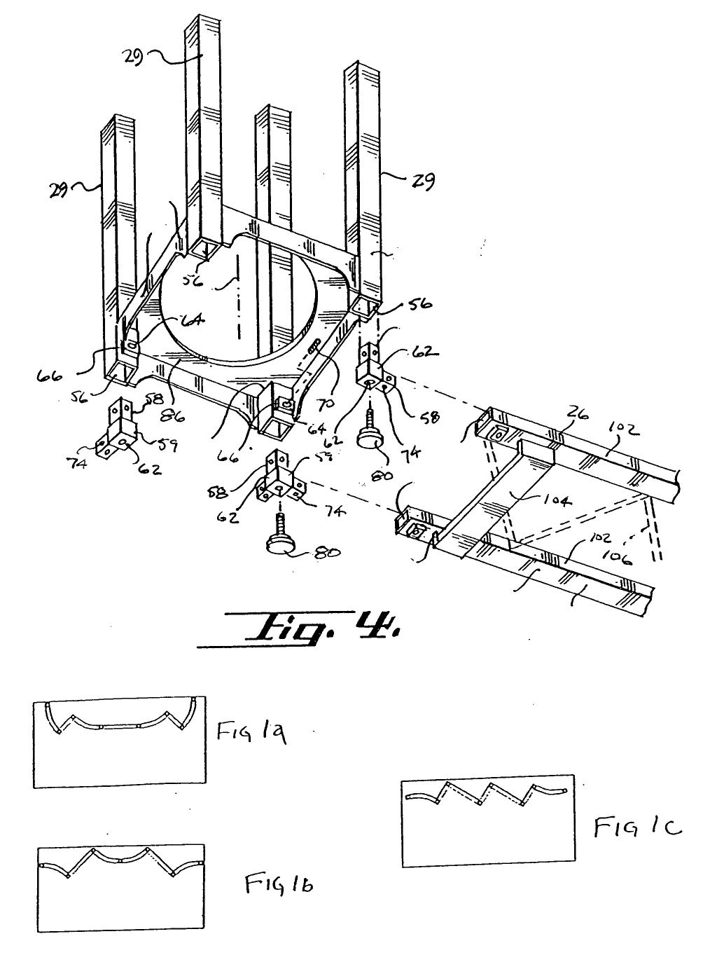

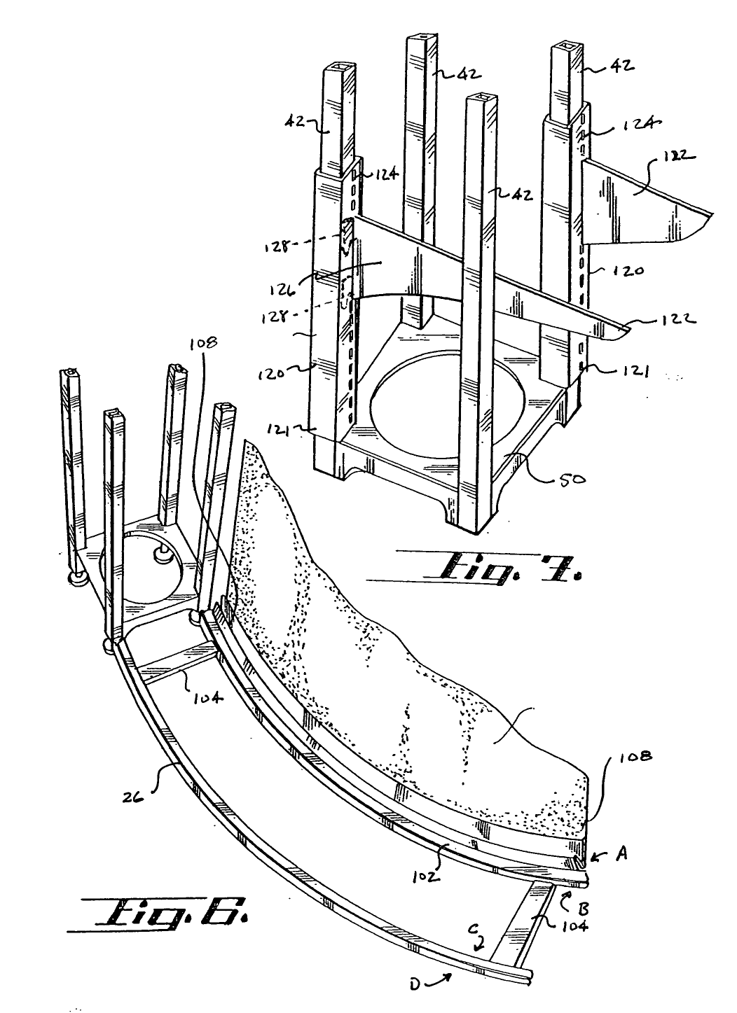

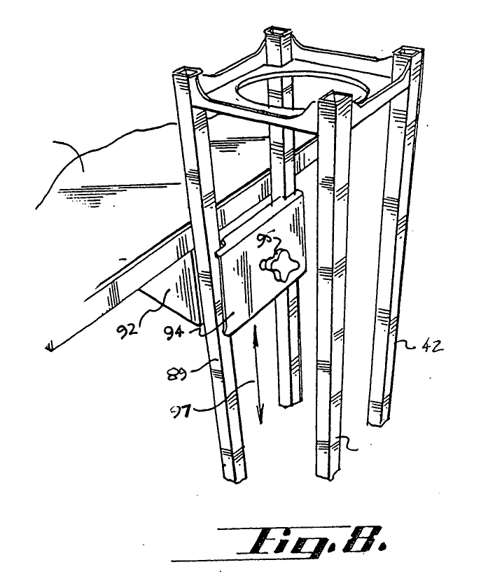

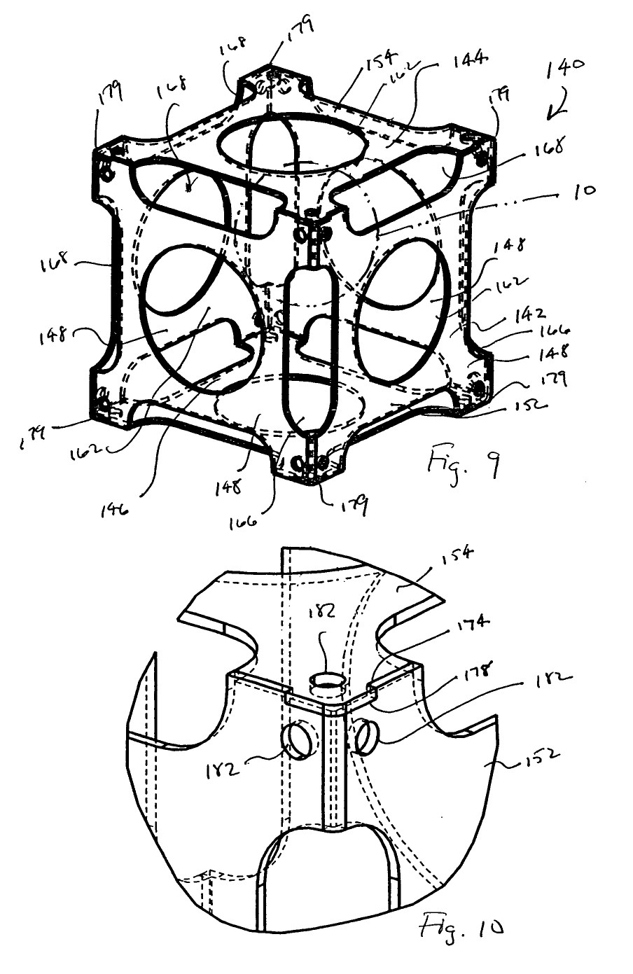

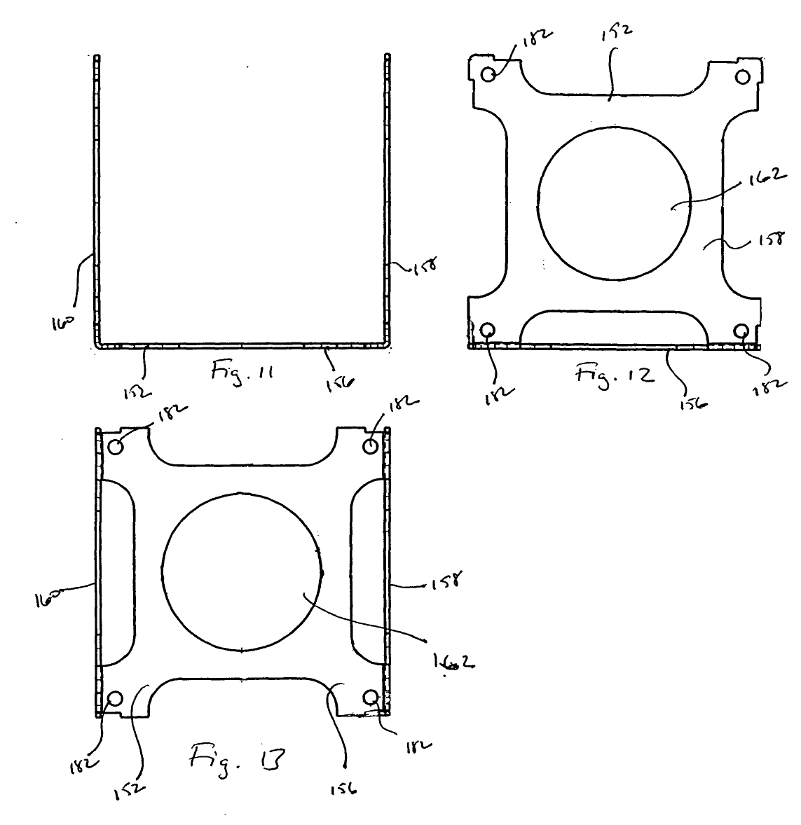

Referring to FIGS. 1 and 2, a portable disassemblable display structure 20 is depicted. Display structure 20 generally includes a framework 22 of a plurality of open vertical columns 24, and a plurality of horizontal trusses 26, including arcuate horizontal spanning members 27 and linear horizontal spanning members 28. The vertical columns 24 and horizontal spanning members 28 define graphical screen window frames 30 defining a plurality of graphical screen windows or openings 32. These may be linear rectangular frame openings 33 or arcuate rectangular frame openings 34, which are linear in the vertical plane and curved, specifically arcuate, in the horizontal plane. The window frames 30 may be generally laid out in a serpentine arrangement to form a structurally stable display due to the serpentine shape.

Referring to FIG. 3, a portion of a vertical column 24 is depicted. The column is composed of two elongated box frames 40, each presenting a longitudinal axis a. Each box frame 40 in a preferred embodiment generally includes four frame segments 42 formed from square steel tubing and arranged in a parallelpiped configuration. Each frame segment 42 has a first end 46 and a second end 48. Each of the respective first ends 46 of the four frame segments 42 is connected by an end webbing 50 as well as are the second ends 48. The ends of the tubing segments 42 are open, defining a socket 56, which facilitates connection to another elongated box frame 40 or to a truss 26. Connections with other box frames 40 or trusses 26 may be made with in line connectors 60 as depicted in FIG. 3, or right angle connectors 62 as depicted in FIG. 4. In line connector 60 has a portion 57, sized so as to be receivable in socket 56 of the frame segments 42. The ends of the elongate box frames 40 also have threaded portions 64 configured as nuts 66 welded onto the ends 48 of the steel tubing frame segments 42. Set screws 70 are threaded through threaded portions 64 to frictionally contact and thereby attach the connectors 60, 62. The connectors will preferably have indentations 74 at the set screw location points. Similarly, the right angle connectors 62 have a portion 58 sized so as to be receivable in socket 56. Right angle connectors 62 may also have body portion 59, which is sized slightly larger than socket 56 as depicted in FIG. 4. The right angle connectors may also have threaded bores 78 for attachment of feet 80 or other appurtenances.

A piece of sheet steel 81 is illustrated in FIG. 5 and 5b, which is suitable for forming the end webbing 50. Sheet steel piece 81 has notches 84 which conform in shape and dimension to the exterior of tubular frame segments 42. Perpendicular portions 85, depicted best in FIG. 5b, are formed by bending sheet steel piece 81 along folding lines 83. To lighten the assembly, end webbing 50 may have one or more apertures 86 defined therein. The end webbing 50 is welded onto each of the four tubular frame segments 42 at welds 43 to form an optimally strong and light structure. Although end webbing 50 as depicted is formed of a single unitary piece, it is also contemplated that webbing 50 could be formed of individual strips of material bridging between individual frame segments 42. Thus, “webbing” is defined as the structure securing segments together, whether a single unitary piece or multiple pieces. Similarly, “bracing” is defined as any structure extending between the frame segments 42. Central aperture 86 and cutouts 103 lighten the structure without significantly reducing the strength of the webbing and further provide an aesthetically pleasing appearance.

Significantly, the elongated box frames 40 have an intermediate portion 89 positioned intermediate the end webbing 50; said intermediate portion 89 does not have any webbing or bracing. This facilitates four “clean” frame segments for variable positioning of appurtenances as illustrated in FIGS. 7 and 8, and for providing an aesthetically pleasing and uncluttered look. In an ideal embodiment the clean intermediate portion 89 without webbing will constitute 70 percent or more of the length of the box frame 40.

As depicted in FIGS. 7 and 8, various appurtenances may be positioned along intermediate portion 89 of box frame 40. In FIG. 7, for example, a shelving support apparatus 120 is depicted. The apparatus generally includes a frame attachment portion 121 and a shelf support member 122. Shelf support member 122 may be a typical shelf support commonly used with adjustable shelving systems. As depicted in FIG. 7, the member 122 typically has a proximal end 126 with a plurality of downwardly directed hooks 128. Frame attachment portion 121 is unshaped so as to fit over and secure to frame segments 42. A plurality of vertically aligned slots 124, each sized to receive a hook 128, are provided in frame attachment portion 121. Each shelf support member 122 may be attached to a frame attachment portion 121 by inserting hooks 128 into corresponding slots 124, and moving the shelf support downwardly, thereby hooking the hooks 128 into the slots 124. Another exemplary embodiment of a shelf support is depicted in FIG. 8. In this embodiment, shelf 90 has projecting portion 92 confronting frame segments 42. Threaded knob 95 extends through clamping portion 94, and threads into projecting portion 92. If threaded knob 95 is tightened, frame segments 42 are trapped and frictionally secured between projecting portion 92 and clamping portion 94, thereby providing a support for shelf 90. Shelf 90 may be positioned in any desired position along frame segments 42 by loosening threaded knob 95, sliding the shelf 90 along the frame segments 42 as depicted by the arrow until the desired position is reached, and retightening threaded knob 95.

Referring to FIGS. 2, 4 and 6, details of the horizontal trusses 26 are illustrated. These trusses 26 may be linear in configuration as illustrated in FIG. 1 and 4 or may be arcuate as illustrated in FIG. 1 and 6. In either case, the trusses have parallel frame segments 102, which may be joined by webbing members 104 proximate the ends, or alternatively by conventional webbing 106 as depicted in FIG. 4.

As illustrated in FIG. 6, the horizontal trusses 26 are utilized for connection of the graphic screen panels 108 which due to the positioning of the u-shaped webbing 104 on the bottom of the bottom truss and the top of the top truss, allows positioning of the screens 108 in four positions as identified by the arrows labeled as A, B, C and D in FIG. 6. This provides an extraordinary amount of flexibility in mounting the graphical screen. The horizontal trusses, in an alternate embodiment of the display may utilize conventional webbing 106 as illustrated by the dashed lines of FIG. 4.

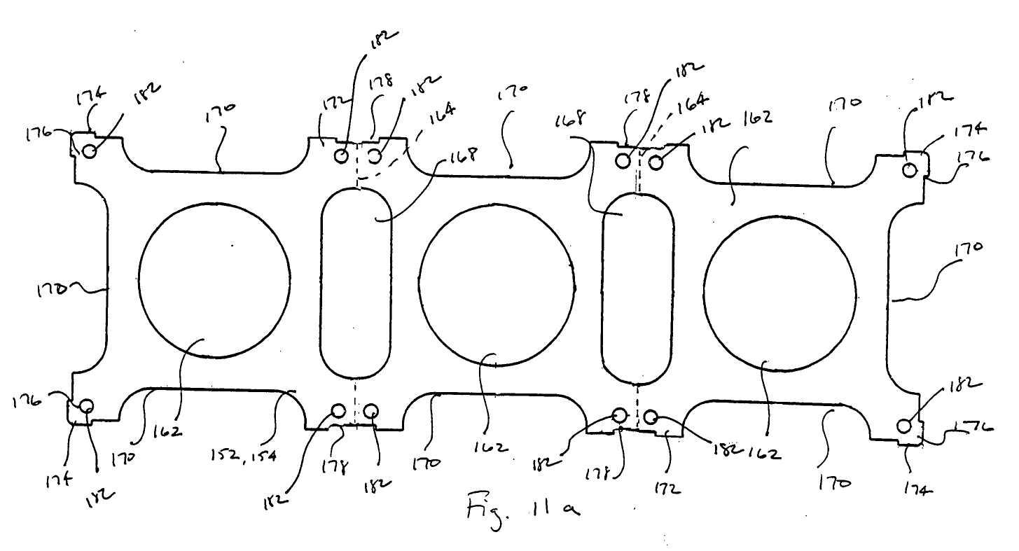

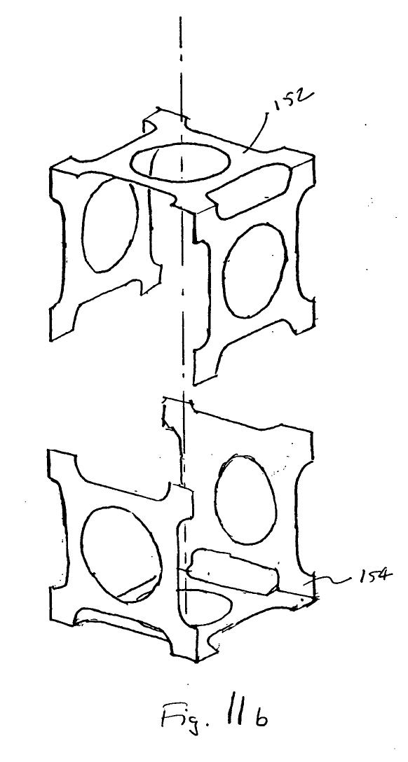

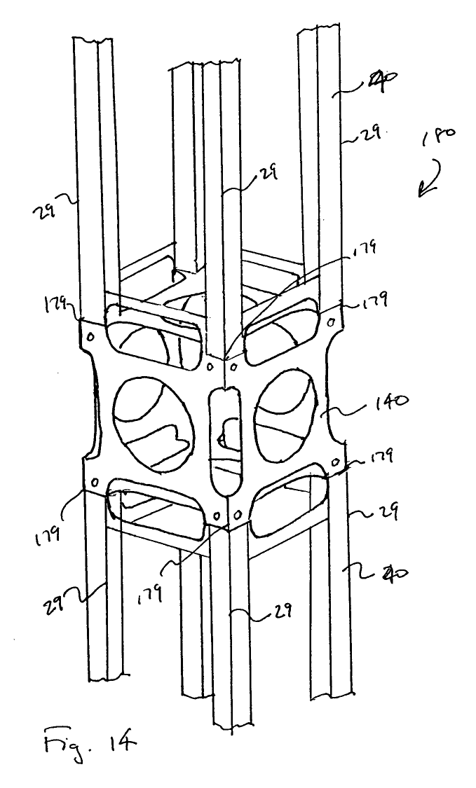

An extension module 140 is depicted in FIGS. 9-14. Extension module 140 may be selectively coupled with one or more box frames 40, trusses 26, or other extension modules 140 to form columns of any desired length and configuration for a multiplicity of display configurations. Extension module 140 is generally a hollow cubic enclosure 142, preferably made from sheet metal, including a top 144, a bottom 146, and four sides 148.

Although hollow enclosure 142 may be formed by any suitable means or methods, in a preferred embodiment, hollow enclosure 142 generally includes a first u-shaped body portion 152 and a second u-shaped body portion 154. Each u-shaped body portion 152, 154, generally includes a center portion 156 and a pair of generally perpendicular opposing side portions 158, 160. Body portions 152, 154, are interfitted together as depicted in FIG. 9a, with center portions 156 opposing and with side portions 158, 160, adjacent and perpendicular so as to define a hollow cube when fully engaged as depicted in FIG. 9.

U-shaped body portions 152, 154, may each be formed from a single flat metal plate 162, which may be bent along bend lines 164 so as to define the u-shape of the body portion 152, 154. Center portion 156 and each side portion 158, 160, may have one or more center apertures 162 defined therein. Corner apertures 166 may be defined within each u-shaped body portion 152, 154, by positioning apertures 168 along bend lines 164. Other corner apertures 168 may be defined between interfitted body portions 152, 154, by providing cutouts 170 in the periphery 172 of plate 162. Center apertures 162 and corner apertures 166, 168, serve to lighten extension module 140 and lend an aesthetically pleasing open appearance. Projecting tabs 174 may be provided at the corners 176 of plate 162, and corresponding receiving notches 178 may be formed in periphery 172 along bend lines 164. When body portions 152, 154, are interfitted, tabs 174 are securely received in notches 178 as depicted best in FIG. 10, so as to form smooth, structural corners. Body portions 152, 154, may be welded together or otherwise fastened together by any suitable means.

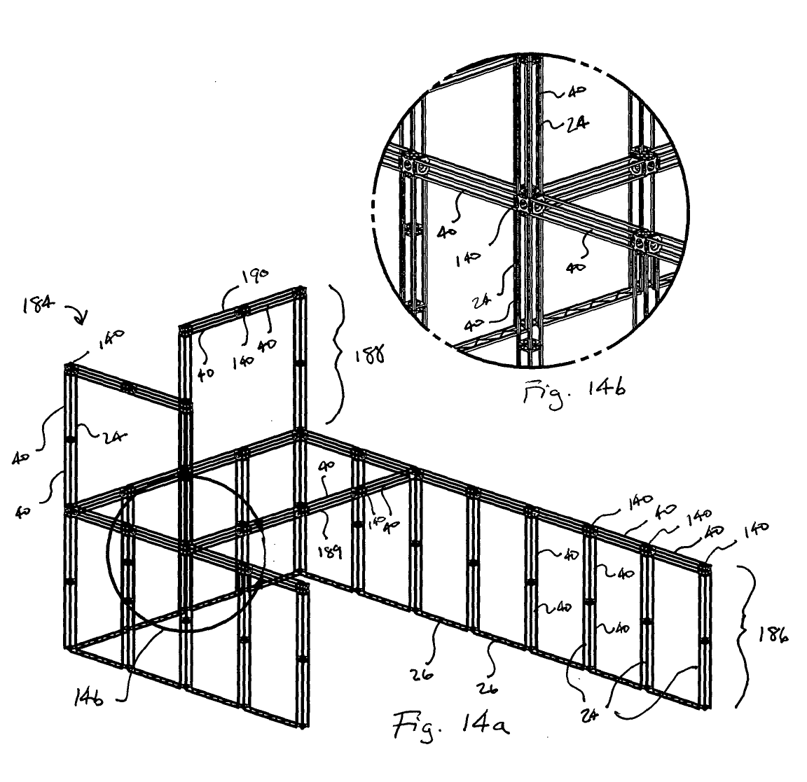

It is most preferred that extension module 140 be of a cubic shape, and sized so that corners 179 of extension module 140 align with outside corners 29 of box frame 40 when extension module 140 is coupled with one or more box frames 40 to form a column structure 180 as depicted in FIG. 14. Cutouts 103 of end webbing 50 in each box frame 40 mate with and mirror the shape of corner apertures 166, 168, to lend an aesthetically pleasing appearance to the overall column structure 180. Extension module 140 may be connected with the box frames 40 using removable fasteners (not depicted) through fastener holes 182, or by any other suitable means.

The center apertures 162 and corner apertures 166, 168, significantly lighten extension module 140 without compromising structural integrity. All three adjacent sides of extension module 140 meet and engage at each comer 179 for optimal structural strength and rigidity. Extension module 140, combined with the open, bracing free, parallelpiped structure of box frame 40, which also is advantageously light and structurally rigid, offers a flexibly configurable, lightweight, structurally rigid, and aesthetically pleasing column assembly for a display structure. One or more sides of extension module 140 may be open, but this configuration is less preferred.

Although depicted herein as a symmetrical cubic form, it will be appreciated that extension module 140 may be made in any other desired geometric shape. For example, sides 148 may be elongated so that extension module 140 has an elongated rectangular cuboid shape. In addition, top 144 and bottom 146, may be hexagonal, octagonal, or any other geometric shape to accommodate box frames 40 having a corresponding geometrical shape.

Although extension module 140 is depicted in FIG. 14 connecting two box frames 40, it will be appreciated that a multiplicity of display configurations are possible with extension module 140, and such configurations are contemplated within the scope of the present invention. For example, an extension module 140 may be positioned at the base of a column in contact with the ground, at the top of the column, or both at the bottom and top of a column. Multiple extension modules 140 may be positioned adjacent between box frames 40, or may be alternated with box frames 40 to form a column of any desired length. In addition, trusses 26 may be connected with extension module 140 using removable fasteners (not depicted) in fastener holes 182 or any other suitable means to form display frames for displaying graphic material.

An exemplary display configuration wherein extension modules 140 are used to assemble a multi-level structure 184 is depicted in FIGS. 14a and 14b. Multi-level structure 184 includes a first level 186 and a second level 188. Vertical columns 24 forming first level 186 each include two stacked elongated box frames 40. Horizontal trusses 26 connect the bottoms of the columns 24, and a first series of extension modules 140 are positioned at the top of each column. Extension modules 140 are horizontally connected with single elongated box frames 40. Alternatively, trusses 26 could be used for these horizontal connections. Longer span horizontal connections may be made with a horizontal truss 189 made from elongated box frames 40 and extension modules 140 connected in alternating fashion.

Second level 188 again includes columns 24, each including two stacked elongated box frames 40. The bottom of each second level column 24 is connected with an extension module 140 of first level 186. Extension modules 140 are also positioned at the top of each of the columns 24 of second level 188. These second level extension modules 140 are connected by a horizontal truss 190 made from a pair of elongated box frames 40 connected by an extension module 140. It will also be appreciated that extension modules 140 may be used to connect with other types and configurations of display systems components. For example, extension modules 140 may be used to connect with tubular display systems such as disclosed in U.S. patent application Ser. No. 10/601,843, previously incorporated herein by reference.

One or more screens 240, which may carry graphics or indicia thereon, may traverse each window frame 30 as depicted in FIG. 1. In a preferred embodiment, screens 240 are generally formed of flexible material. Screens 240 are primarily rectangular in shape and are formed of material such as textile material, vinyl, or other known sheet materials of flexible and inflexible make-up. The sheet screens 240 are removably mounted to horizontal trusses 26. The screens 240 comprise the rectangular sheet material 246 and a mounting apparatus 250.

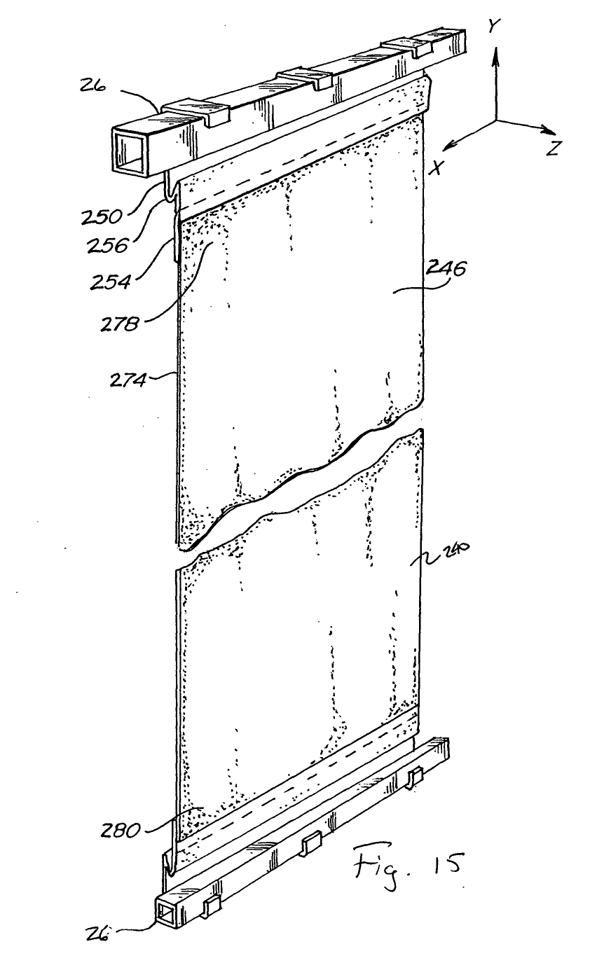

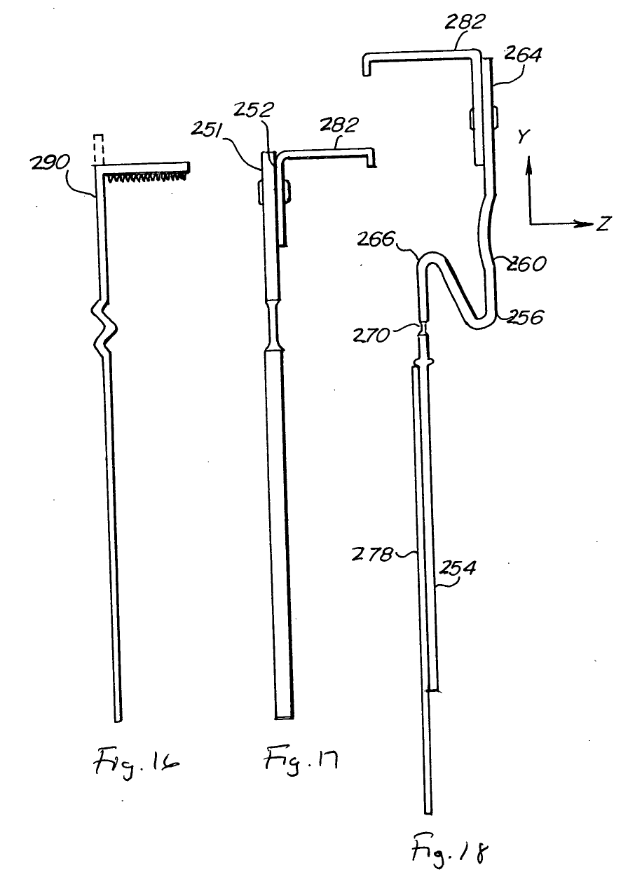

Referring to FIGS. 15, 16, 17, and 18, details of the mounting apparatus 250 are depicted. The mounting apparatus is principally comprised of a frame attachment 251 or clasping portion 252, a screen material attachment portion 254, and a bias providing elastic portion 256.

The screen mounting apparatus 250 is preferably formed from an extruded piece 260 of thermoplastic material. In a preferred embodiment, the extrusion 260 will be formed of at least two different materials having different characteristics. Polyvinyl chloride (PVC) has been found to be a very suitable material for specific portions of the extrusion 260. For example, the portion 264 of the extrusion 260 that is part of the attachment portion 251 of the apparatus as well as the screen material attachment portion 254 may be made of PVC. Also, in certain embodiments in which the elastic portion 256 is formed of a spring section 266 having at least a C-shape in the cross-section or further folds to comprise an S-shape or perhaps more folds. Additionally, a second material generally of a lower durometer and having greater flexibility may be utilized in embodiments of the screen mounting apparatus 250 in which the elastic portion 256 does not rely exclusively or principally upon folds in the extrusion. Additionally, this second plastic portion may be generally narrower than the rest of the extrusion, adding further elastic characteristics and also providing advantageously a living hinge 270 which facilitates the folding and rolling up of the screen when not in use.

The screen material attachment portion 254 generally extends the width of the rectangular screen material piece as well as the width of the screen mounting apparatus. Although, in certain instances it may be desirable to have the screen attachment portion 254 extending beyond the lateral edges 274 of the screen material piece for aesthetic or other reasons. The screen material portion may be of fabric, vinyl material, or other flexible, foldable thin sheet material. In addition, non-flexible sheet materials can be used, depending on the elastic characteristics of the elastic portion 256. Upper and lower horizontal extending strips 278, 280 are secured to the screen material attachment portion 254 by way of adhesive or other suitable attachment means.

Frame attachment portion 251 may be configured as a clasping portion 252 having hook-shape members 282. Such hook materials may be formed of appropriately shaped sheet metal such as steel. The hook-shape would be suitably sized for the support member. Such hook members may be attached to extrusion 260 by way of rivets or other suitable fastening means. Such hook member may include a strip of magnetic material 288 to secure the attachment of the mounting apparatus to the support member 242. Other configurations could utilize an L-shape member 290 as part of the extrusion with a piece of hook and loop material such as Velcro® extending along the width or along portions of the width of the extrusion.

The present invention may be embodied in other specific forms without departing from the spirit or essential attributes thereof, and it is therefore desired that the present embodiment be considered in all respects as illustrative and not restrictive, reference being made to the appended claims rather than to the foregoing description to indicate the scope of the invention.

What is claimed is:

1. A modular multi-configurable display system comprising:
a plurality of columns arranged in a series, each column including at least one elongated box frame, said at least one elongated box frame comprising:
at least four spaced apart elongate members, each having a pair of opposing ends; and
a pair of opposing end webbing members, each end webbing member connecting the at least four elongate members proximate a separate one of the pair of opposing ends so as to define a substantially open parallelpiped and defining a length of each elongate member between the end webbing members, each of the pair of end webbing members including an end plate portion and a plurality of side portions integral with the end plate portion, each of the plurality of side portions positioned so as to span between and bridgingly support a separate pair of the at least four elongate members, the length of each elongate member defined between the end webbing members being substantially free from bracing; and
at least one pair of horizontal trusses connecting the columns, each horizontal truss including a pair of elongate frame segments, the at least one pair of horizontal trusses being spaced apart and defining at least one open graphic screen frame between adjacent columns.

2. The modular multi-configurable display system of claim 1, wherein the horizontal trusses are arcuate shaped, each including a pair of arcuate frame segments.

3. The modular multi-configurable display system of claim 1, wherein the horizontal trusses are linear, each linear truss including a pair of linear frame segments.

4. The modular multi-configurable display system of claim 1, wherein each column includes at least two stacked elongate box frames.

5. The modular multi-configurable display system of claim 1, wherein the at least one elongated box frame of each column has a pair of opposing ends, wherein each of the at least four elongate members defines an outside comer of the at least one elongated box frame, and further comprising at least one extension module selectively operably couplable with one of the pair of opposing ends of the at least one elongated box frame, the extension module comprising a hollow, sheet metal enclosure having at least four sides, the four sides intersecting at four outside corners, each of the four outside corners of the extension module aligned with a separate one of the outside corners of the elongated box frame when the extension module is coupled with the elongated box frame.

6. The modular multi-configurable display system of claim 5, wherein each column includes two elongated box frames, and wherein the extension module is operably coupled to each of the elongated box frames.

7. The modular multi-configurable display system of claim 5, wherein one of the pair of horizontal trusses is operably coupled to the extension module.

8. The modular multi-configurable display system of claim 5, wherein the extension module comprises a pair of u-shaped body portions.

9. The modular multi-configurable display system of claim 5, wherein the extension module is a cube.

10. The modular multi-configurable display system of claim 5, wherein the extension module is operably coupled with a tubular display system component.

11. The modular multi-configurable display system of claim 1, further comprising at least one shelf support member and means for attaching said at least one shelf support member to one of the plurality of columns.

12. The modular multi-configurable display system of claim 1, further comprising a screen and a screen mounting apparatus for removably mounting the screen in the at least one open graphic screen frame, the screen mounting apparatus comprising:
a frame clasping attachment portion removably securable to the horizontal trusses;
a screen material attachment portion adapted to fixedly receive an end portion of the screen such that substantially the entire length of the end portion of the screen is fixedly received; and
an elastic portion joining the frame clasping portion and the screen attachment portion such that appropriate force upon the screen attachment portion results in an appropriate resilient displacement of the apparatus.

13. The modular multi-configurable display system of claim 1, wherein the extension module has a plurality of central apertures and a plurality of corner apertures defined therein.

14. A modular multi-configurable display system comprising:
a pair of spaced apart elongated columnar structures, each including at least one elongate substantially open paralellpiped structure having a pair of opposing ends, the parallelpiped structure comprising a plurality of spaced apart elongate members operably coupled by a pair of spaced apart opposing end webbing members, each elongate member defining an outside corner of the parallelpiped structure;
at least one extension module selectively operably couplable with one of the pair of opposing ends of the at least one paralellpiped structure, wherein the extension module comprises a hollow, sheet metal enclosure having at least a top, a bottom, and four sides, the four sides intersecting at four outside corners, each of the four outside corners of the extension module aligned with a separate one of the outside corners of the paralellpiped structure when the extension module is coupled with the parallelpiped structure; and
a pair of spaced-apart horizontal trusses connecting the columnar structures, the pair of trusses and the pair of columnar structures defining an open graphic screen frame.

15. The modular multi-configurable display system of claim 14, wherein the horizontal trusses are arcuate shaped, each including a pair of arcuate frame segments.

16. The modular multi-configurable display system of claim 14, wherein the horizontal trusses are linear, each linear truss including a pair of linear frame segments.

17. The modular multi-configurable display system of claim 14, wherein each columnar structure includes at least two parallelpiped structures.

18. The modular multi-configurable display system of claim 14, wherein the extension module is a cube.

19. The modular multi-configurable display system of claim 18, wherein the extension module comprises a pair of u-shaped body portions.

20. The modular multi-configurable display system of claim 14, wherein the extension module has a plurality of central apertures and a plurality of corner apertures defined therein.

21. The modular multi-configurable display system of claim 14, wherein said end webbing members each have a plurality of cutout portions.

22. The modular multi-configurable display system of claim 14, wherein the outer surface of each elongate member is substantially free of bracing and webbing between the end webbing members.

23. The modular multi-configurable display system of claim 14, further comprising a screen and a screen mounting apparatus for removably mounting the screen in the open graphic screen frame, the screen mounting apparatus comprising:
a frame clasping attachment portion removably securable to the horizontal trusses;
a screen material attachment portion adapted to fixedly receive an end portion of the screen such that substantially the entire length of the end portion of the screen is fixedly received; and
an elastic portion joining the frame clasping portion and the screen attachment portion such that appropriate force upon the screen attachment portion results in an appropriate resilient displacement of the apparatus.

24. A modular multi-configurable display system comprising:
a plurality of columns arranged in a serpentine pattern, each column having a top and a bottom and including a plurality of elongated box frames, each elongated box frame comprising a plurality of spaced apart parallel elongate frame segments, each segment having a pair of opposing ends, the frame segments connected by end webbing proximate each of the opposing ends defining a portion of each frame segment therebetween, the portion of each frame segment defined between the end webbings being free from bracing thereby presenting an unobstructed length adapted for attaching at least one appurtenance; and
a plurality of pairs of trusses, each pair of trusses arranged so as to connect each column to at least one adjacent column in the pattern, the trusses in each pair being spaced apart so as to define an open graphic screen frame between the adjacent columns for mounting and displaying a graphic screen.

25. The modular multi-configurable display system of claim 24, further comprising a screen and means for attaching the screen in the open graphic screen frame.

26. The modular multi-configurable display wall system of claim 24, further comprising at least one shelf support member and means for attaching the at least one shelf support member to one of the box frames.

27. The modular multi-configurable display system of claim 24, further comprising a plurality of extension modules, each selectively operably couplable with a separate one of the plurality of columns, each extension module comprising a hollow, sheet metal enclosure having at least four sides.

28. The modular multi-configurable display system of claim 27, wherein each extension module comprises a pair of u-shaped body portions.

29. The modular multi-configurable display system of claim 27, wherein each extension module is a cube.

30. The modular multi-configurable display system of claim 27, wherein at least one extension module is operably coupled with a tubular display system component.
